(19) United States
(12) Patent Application Publication
(10) Pub. No.: US 2013/0103668 A1
(43) Pub. Date: Apr. 25, 2013

(54) QUESTION CONVERSION FOR INFORMATION SEARCHING

(71) Applicant: John R. Wullert, II, Martinsville, NJ (US)

(72) Inventor: John R. Wullert, II, Martinsville, NJ (US)

(73) Assignee: TELCORDIA TECHNOLOGIES, INC., Piscataway, NJ (US)

(21) Appl. No.: 13/278,673

(22) Filed: Oct. 21, 2011

(51) Int. Cl. G06F 17/30

(52) U.S. Cl. 707/710; 707/768; 707/E17.108; 707/E17.064

(57) ABSTRACT

A question conversion engine converts terms and phrases used in a user's question into terms and phrases that are more likely to produce information containing the search terms. The question conversion engine parses a user's question to associate each term in the user's question with a part of speech and to eliminate extraneous terms in the user's question. A term/phrase replacement map is used to replace terms and/or phrases in the user's question with replaced terms and phrases that are more likely to produce relevant information. The question conversion engine matches the user's question to a declarative expression thereby altering the semantics of the question into an expression that is more likely to produce optimum search results.

### BACKGROUND

1. Field of the Invention

The present invention relates generally to the field of data processing, and more particularly to query formulation for information retrieval.

2. Description of the Related Art

A search engine is used to perform a search to retrieve information accessed from web sites and services from the Internet. A user engages the search engine to perform a search through a query that contains one or more search terms. The results of the query rely on the selection of the search terms used in the query. Misspelled terms or typographical errors in a query often produce poor results since these search terms do not retrieve information pertinent to the user's query.

In order to improve the search results, a search engine may expand the query by including additional search terms in the query. These additional search terms may come from a dictionary or a thesaurus and identify synonyms for the search terms used in the query. The additional search terms are often a broader set of terms than originally intended so that the search produces a larger set of results. However, a larger set of results may not retrieve information of interest to the user and often results in excessive search time to scan the results for relevant information.

Accordingly, the choice of search terms used in a query is an important factor in generating search results that produce relevant information.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A question conversion engine converts search terms used in a user's question into an expression that is more likely to produce pertinent search results. The question conversion engine may change the semantics of the question into an expression that contains search terms that will appear in the search results.

The question conversion engine utilizes a question parsing procedure to parse a user's question and attribute a part of speech identifier to each term and/or phrase used in the user's question. The more pertinent terms and phrases are identified. A phrase replacement procedure utilizes a term/replacement map to replace certain terms and phrases in the user's question with other terms and phrases that are more likely to produce relevant results. The resulting expression is then used by a search engine to search for the desired information.

The term/replacement map contains replacement phrase rules having a left hand side phrase that when matched is replaced by a right hand side phrase. The replacement phrase rules may be automatically generated from searches of sets of question and answer pairs, such as frequently asked questions (FAQ) and answers. A phrase replacement procedure may be utilized to analyze FAQs and answers to determine the most frequently used terms that appear in search results although not in a question.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary computing environment for information searching.

FIG. 2 illustrates a first example of the question conversion process.

FIG. 3 illustrates a second example of the question conversion process.

FIG. 4 is a flow diagram illustrating a first exemplary method for question conversion.

FIG. 5 is a flow diagram illustrating a second exemplary method for question conversion.

FIG. 6 is a flow diagram illustrating an exemplary method for generating the term/phrase replacement map.

FIG. 7 is a block diagram of components of an exemplary computing device utilizing the question conversion technology.

### DETAILED DESCRIPTION

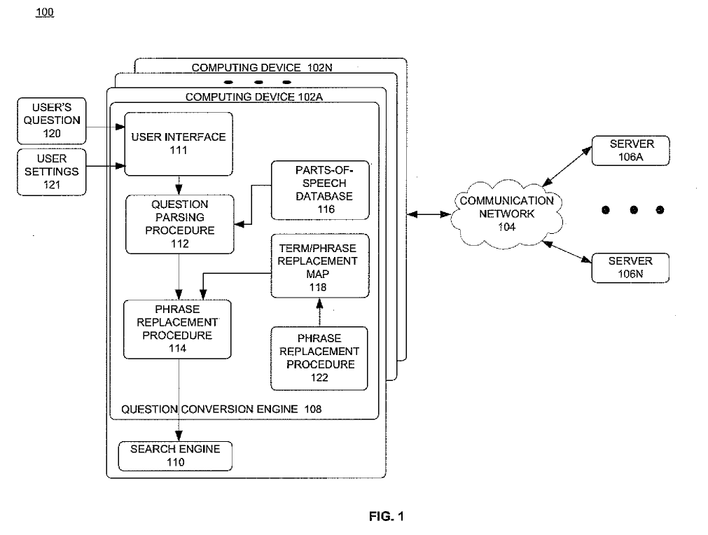

FIG. 1 illustrates an exemplary system 100 for question conversion in information searching. The system 100 may include one or more computing devices 102A-102N (collectively, ‘102’), a communications network 104, and one or more servers 106A-106N (collectively, ‘106’). A computing device 102 may be any type of electronic computing device such as, without limitation, a mobile device, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, router, gateway, or any combination thereof.

The communications network 104 facilitates communications between a computing device 102 and a server 106. The communications network 104 may be a local-area network, a wide-area network, or any combination thereof. In several embodiments, the communications network 104 may be the Internet. A server 106 may be any type of electronic computing device that is dedicated to running a service. A server 106 may be a web server, an application server, a file server, a database server, a web site, and the like.

The computing device 102 may include a question conversion engine 108 and a search engine 110. The question conversion engine 108 receives a user's question 120 and converts the question into a declarative expression rather than a question. The search engine 110 receives the declarative expression and searches for documents that contain the search terms in the declarative expression. By converting the question into a declarative expression, the question conversion engine 108 alters the semantics of the question.

The question conversion engine 108 may include a user interface 111, a question parsing procedure 112, a phrase replacement procedure 114, a parts-of-speech database 116, a term/phrase replacement map 118, and a phrase replacement procedure 122. The user interface 111 accepts input from the user such as user questions 120 and user settings 121 for the question conversion engine 108. The user settings 121 may be used to enable and disengage the question conversion engine 108.

The question parsing procedure 112 accepts a user's question 120 and parses it to determine the parts of speech for each term or phrase in the user's question 120. The question parsing procedure 112 may utilize a parts-of-speech database 116 that contains frequently used words and a corresponding part of speech. The parts-of-speech database 116 may be configured to recognize eight parts of speech such as, a noun, a verb, a pronoun, an adjective, an adverb, a preposition, a conjunction, and an interjection. However, the embodiments are not constrained to this particular configuration of the parts of speech and other variations may be used instead.

The user's question 120 and the corresponding parts-of-speech annotations may then be passed to the phrase replacement procedure 114. The phrase replacement procedure 114 maps the user's question into a declarative expression. The phrase replacement procedure 114 may utilize the term/phrase replacement map 118 to construct an appropriate declarative expression that utilizes terms that may be found in the information that is retrieved.

The term/phrase replacement map 118 may be generated in a number of ways. For example, a team of developers may manually generate the term/phrase replacement map 118 based on exemplary questions and developer-generated responses. This manual approach offers the value of human intelligence at the expense of consuming a considerable amount of time and effort.

Alternatively, a phrase replacement procedure 122 may be executed offline to search for a large set of question and answer pairs, such as frequently asked questions (FAQ) documents and answers that are used by search engines across the Internet. The phrase replacement procedure 122 may parse the FAQ documents to analyze the terms and phrases used most often in answers that may be used to generate the rules for the term/phrase replacement map 118.

The term/phrase replacement map 118 may be embodied in the form of a context-free grammar that consists of multiple expressions. Each expression is configured as a rule having a left hand side phrase that maps into a right hand side phrase. When the terms and/or phrases in the user's question match the left hand side phrase of an expression, they are replaced with the right hand side phrase.

The question parsing procedure 112, the phrase replacement procedure 114, and the search engine 110 each may be embodied as a software application, procedure, program, module and the like. The part-of-speech database 116 and the term/phrase replacement map 118 may be embodied as a database, lookup table, hash table, and the like.

Although the system 100 shown in FIG. 1 has a limited number of elements in a certain configuration, it should be appreciated that the system 100 can include more or less elements in alternate configurations. For example, all or portions of the question conversion engine 108 may be incorporated into the search engine 110 or in a user interface application that is separate from the search engine 110. The embodiments are not limited in this manner.

In various embodiments, the system 100 described herein may comprise a computer-implemented system having multiple components, programs, procedures, modules. As used herein these terms are intended to refer to a computer-related entity, comprising either hardware, a combination of hardware and software, or software. For example, a component may be implemented as a process running on a processor, a hard disk drive, multiple storage drives (of optical and/or magnetic storage medium), an object, an executable, a thread of execution, a program, and/or a computer. By way of illustration, both an application running on a server and the server may be a component. One or more components may reside within a process and/or thread of execution, and a component may be localized on one computer and/or distributed between two or more computers as desired for a given implementation. The embodiments are not limited in this manner.

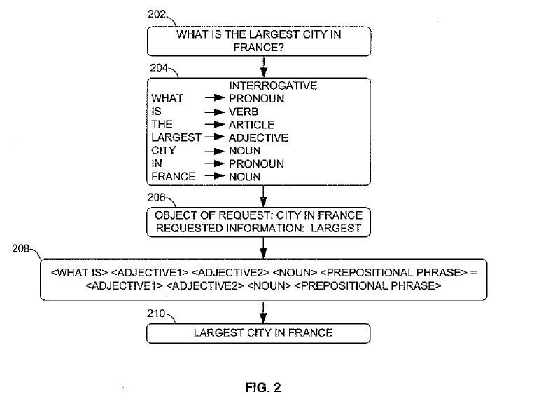

Attention now turns to an example illustrating a question being converted for information retrieval. Referring to FIG. 2, a user may enter the question, “What is the largest city in France?” (block 202). The question parsing procedure 112 receives this question and utilizes the parts-of-speech database 116 to parse each word in the user's question into a respective part of speech (block 204). Once the part of speech of each word is determined, the question parsing procedure 112 may determine the object of the request and the requested information (block 206). In other words, the question parsing procedure 112 determines which terms are relevant and which are extraneous. For example, the object of the request may be a “City in France” and the requested information may be “Largest” (block 206).

Next, the phrase replacement procedure 114 searches the term/phrase replacement map 118 for one or more replacement phrases. As shown in FIG. 2, the phrase replacement procedure 114 may utilize the expression shown in block 208 as a suitable expression to convert the question, “What is the largest city in France?” into “Largest City in France” (block 210). The resulting declarative expression may then be used by the search engine 110 to find documents containing the search terms in the converted phrase.

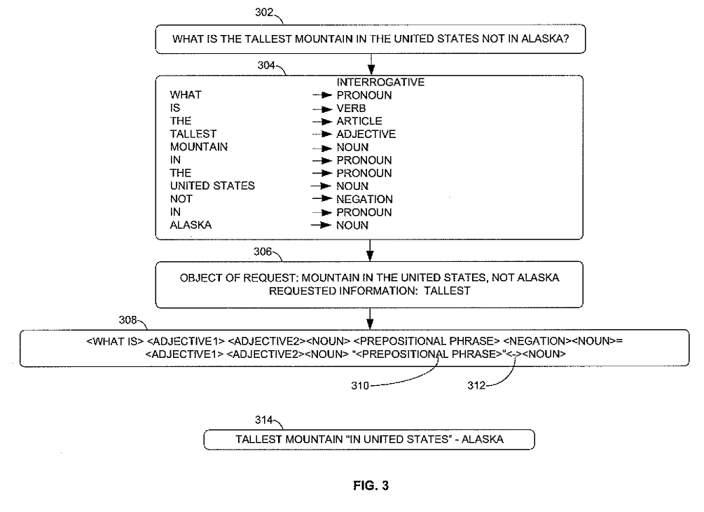

Attention now turns to a second example to illustrate the question conversion process on a question containing a negation. Referring to FIG. 3, a user may enter the question, “What is the tallest mountain in the United States not in Alaska?” (block 302). The question parsing procedure 112 receives this question and utilizes the parts-of-speech database 116 to parse each word in the user's question into a respective part of speech (block 304). Once the part of speech of each word is determined, the question parsing procedure 112 may determine the object of the request and the requested information (block 306). In other words, the question parsing procedure 112 determines which terms are relevant and which are extraneous. For example, the object of the request may be a “Mountain in the United States, not Alaska” and the requested information may be “Tallest” while all other terms are deemed irrelevant and extraneous (block 306).

Next, the phrase replacement procedure 114 searches the term/phrase replacement map 118 for one or more replacement phrases. In this particular example, the left hand side of the question is matched with the parts of speech in the left hand side of the rule and a declarative expression is formed in accordance with the right hand side of the rule. The right hand side of the rule has a prepositional phrase in quotes 310 (e.g., “<prepositional phrase>”) and a dash 312 before a noun (−) to denote a negated term (e.g., not Alaska).

As shown in FIG. 3, the phrase replacement procedure 114 may utilize the expression shown in block 314 to replace the question, “What is the tallest mountain in the United States not in Alaska?” into “Tallest Mountain “in United States”—Alaska” (block 310). The resulting declarative expression may then be used by the search engine 110 to find documents containing the search terms in the converted phrase.

Attention now turns to a more detailed discussion of the operations for the embodiments with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

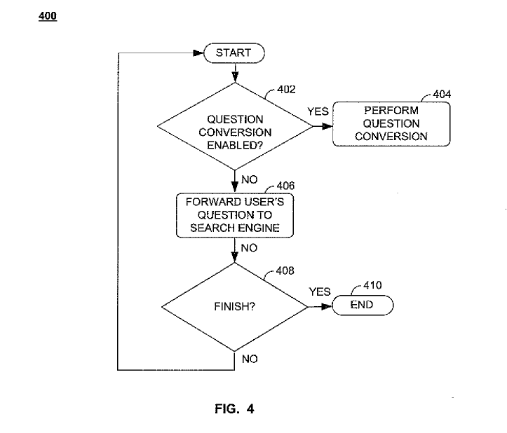

FIGS. 4-6 illustrate flow diagrams of exemplary methods for question conversion for information searching. It should be noted that the methods 400, 404, 600 may be representative of some or all of the operations executed by one or more embodiments described herein and that the methods can include more or less operations than that which is described in FIGS. 4-6. In an embodiment, the methods may be performed by the question conversion engine 108.

Referring to FIG. 4, a user interface 111 may obtain user settings 121 that may enable the question conversion engine 108 or disable the question conversion engine 108. When the question conversion engine 108 is enabled (block 402-yes), the question conversion engine 108 processes the user's question (block 404). Otherwise (block 402-no), the user's question 120 is transmitted to the search engine 110 without any question conversion (block 406). The process may repeat (block 408-yes) until operations finish (block 408-no, block 410).

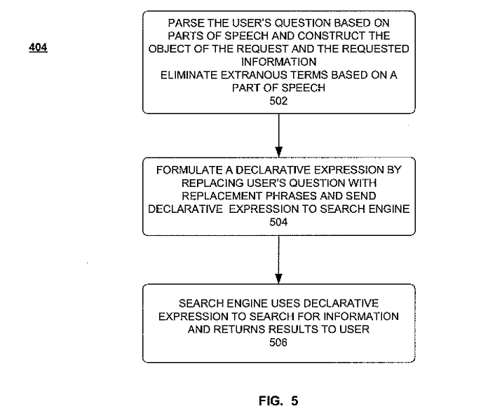

Referring to FIG. 5, the question parsing procedure 112 parses the user's question to identify the parts of speech that appear in the user's question 120 (block 502). The question parsing procedure 112 uses this information to determine the object of the request and the requested information thereby eliminating extraneous terms and phrases (block 502). The object of the request and the requested information may then be sent to the phrase replacement procedure 114 (block 502).

The phrase replacement procedure 114 uses the user's question, the object of the request, and the requested information to construct a declarative expression using one or more replacement phrases from the term/replacement map 118 (block 504). The declarative expression may then be passed onto the search engine 110 (block 504). The search engine 110 uses the declarative expression to search for the information and returns the search results to the user (block 506).

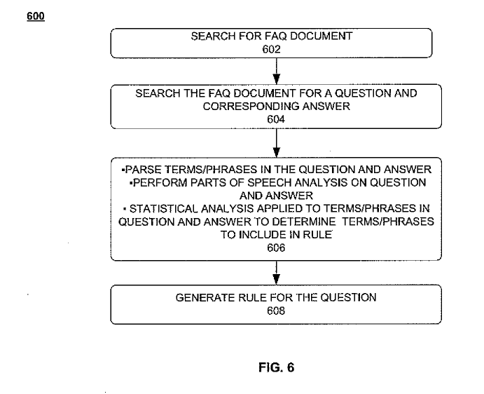

Attention now turns to FIG. 6 which illustrates an exemplary method for generating the term/phrase replacement map. A phrase replacement procedure 122 may be utilized to search the Internet for FAQ documents that contain questions and answers (block 602). The FAQ document may be parsed to find a question and its corresponding answer (block 604). In some embodiments, the phrase replacement procedure 122 may search for a question having a specific format while in other embodiments the question may be randomly selected (block 604).

The phrase replacement procedure 122 parses the question to determine the question and the answer from the text in the FAQ document (block 604). The question parsing procedure 112 may be used to make this determination (block 604). In addition, the parts of speech of each term and phrase in the question is determined as well as the parts of speech of each term and phrase in the answer (block 604).

The phrase replacement procedure 122 may then analyze the question and its answer to determine the frequency that certain terms in the question appear in the answer (block 606). In addition, the phrase replacement procedure 122 may utilize a statistical technique to determine the frequency that certain parts of speech occur in an answer when a certain term is used in a question (block 606). This analysis may then generate a rule or declarative expression that is added to the term/replacement map 118 (block 608).

For example, the question “How far is it from New York to Los Angeles?” may be found in a FAQ document. The answer may contain the phrase “It is 3,500 miles from New York to Los Angeles.” The phrase replacement procedure 122 may generate a rule that uses the term “miles” in a question having the phrase “how far” based on an analysis that shows the term “miles” often appearing in the search results of questions containing the term “how far.” In this example, the question may be converted into the phrase “miles New York Los Angeles” since this phrase contains terms that are more likely to appear in the search result.

The embodiments described herein are focused on improving the search terms used in a query so that the results contain the information that is requested rather than pointers or documents to web sites that contain one or more of the search terms in the user's question. Searches posed in the form of a query may not produce optimum search results since the words in the query are not necessarily found in the retrieved information. The conversion of the user's question into a declarative expression containing those search terms that are more likely to appear in the retrieved information results in altering the semantics of the user's question. In this manner, the user obtains more relevant documents more readily and does not incur the additional expense of searching through irrelevant retrieved documents.

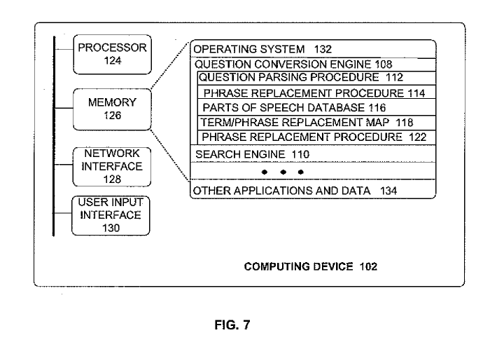

Attention now turns to a more detailed description of the components of computing device 102. Referring to FIG. 7, the computing device 102 may be utilized in a system configured in a network environment, a distributed environment, and/or a multiprocessor environment. However, it should be noted that the configuration shown in FIG. 7 is exemplary and not intended to suggest any limitation as to the functionality of the embodiments.

The computing device 102 may include a processor 124, a memory 126, a network interface 128, and a user input interface 130. The processor 124 may be any commercially available processor and may include dual microprocessors and multi-processor architectures. The network interface 128 facilitates wired or wireless communications between the computing device 102 and a communications network 104 in order to provide a communications path between the computing device 102 and the servers 106. The network interface 128 may be used to facilitate network communications through a communications network 104. The user input interface 128 accepts user input from input devices, such as a mouse, keyboard, touch screen, and the like.

The memory 126 may be any computer-readable storage media or computer-readable media that may store processor-executable instructions, procedures, applications, and data. The computer-readable media is a non-transitory media that does not pertain to propagated signals, such as a modulated data signal transmitted through a carrier wave. It may be any type of memory device (e.g., random access memory, read-only memory, etc.), magnetic storage, volatile storage, non-volatile storage, optical storage, DVD, CD, floppy drive, disk drive, flash memory, and the like. The memory 126 may also include one or more external storage devices or remotely located storage devices. The memory 126 may contain instructions and data as follows:
an operating system 132;
a question conversion engine 108 having a question parsing procedure 112, a phrase replacement procedure 114, a parts of speech database 116, a term/phrase replacement map 118, and a phrase replacement procedure 122;
a search engine 110; and
various other applications and data 134.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

What is claimed:

1. A computer-implemented method, comprising:
obtaining a user question, the user question having a plurality of terms;
converting the user question into a declarative expression, the declarative expression having one or more replaced terms, each replaced term replacing a term from the user question; and
searching for information matching the declarative expression.

2. The computer-implemented method of claim 1, wherein the converting step further comprising:
parsing each term in the user question to identify a part of speech for each term; and
eliminating an extraneous term in the user question based on a part of speech for the extraneous term.

3. The computer-implemented method of claim 2, wherein parsing each term in the user question to identify a part of speech for each term, utilizes a part of speech database.

4. The computer-implemented method of claim 1, further comprising:
providing a term/phrase replacement map, the term/phrase replacement map having a plurality of expressions; and
replacing the user question in accordance with an expression in the term/phrase replacement map to generate the declarative expression.

5. The computer-implemented method of claim 4, further comprising:
generating an expression from analyzing a plurality of question and answer pairs found in documents.

6. The computer-implemented method of claim 5, the generating step further comprising:
determining terms in answers of question and answer pairs that are more frequently used than terms in questions of question and answer pairs; and
creating an expression that maps a term in a user question into a term found in answers of question and answer pairs that are more frequently used.

7. The computer-implemented method of claim 1, wherein the declarative expression is not a question.

8. The computer-implemented method of claim 4, further comprising:
matching the user question with a left hand side phrase of an expression and replacing the user question with the right hand side phrase of an expression.

9. The computer-implemented method of claim 5, wherein the search engine performs Internet searches to retrieve the frequently asked questions.

10. A non-transitory computer-readable storage medium storing thereon processor-executable instructions, comprising:
a question conversion engine having instructions that when executed on a processor, converts a user question into a declarative expression, the user question having a sequence of user terms, the declarative expression having a sequence of search terms, the declarative expression constructed from mapping a sequence of user terms into a sequence of search terms.

11. The non-transitory computer-readable storage medium of claim 10, further comprising:
a term/phrase replacement map, the term/phrase replacement map including a plurality of expressions, each expression having a sequence of user terms and a corresponding sequence of search terms;
wherein the question conversion engine finds an expression that matches the sequence of user terms in the term/phrase replacement map and replaces the sequence of user terms with the corresponding sequence of search terms in the term/phrase replacement map.

12. The non-transitory computer-readable storage medium of claim 10, further comprising:
a parts-of-speech database including a plurality of terms, each term having an associated part of speech;
wherein the question conversion engine parses each term in the user question and associates each term with a part of speech using the parts-of-speech database.

13. The non-transitory computer-readable storage medium of claim 12, further comprising:
a phrase replacement procedure having instructions that when executed on a processor, analyzes sets of question and answer pairs to determine terms in an answer that are more frequently used than terms in a question and which use the terms in the answer that are more frequently used in the declarative expression.

14. The non-transitory computer-readable storage medium of claim 13, wherein the phrase replacement procedure having instructions that when executed on a processor, determine parts of speech that are more frequently used in an answer than in a question and use a more frequently used part of speech found in the answer in the declarative expression.

15. The non-transitory computer-readable storage medium of claim 10, wherein the declarative expression is not a question.

16. A computer-implemented system, comprising:
a computing device having a processor and a question conversion engine, the question conversion engine including instructions that when executed on a processor, receives a user question, the user question including a sequence of user terms, the question conversion engine including further instructions that when executed on a processor, converts the question into a declarative expression, the declarative expression having a sequence of search terms, the declarative expression not being a question.

17. The computer-implemented system of claim 16, further comprising:
a network; and
the computing device including a search engine, the search engine coupled to the network, the search engine including instructions that when executed on the processor, uses the declarative expression to search for documents over the network that contain the search terms.

18. The computer-implemented system of claim 16, further comprising:
a term/phrase replacement map containing a plurality of expressions, each expression having a sequence of user terms and a sequence of search terms; and
wherein the question conversion engine, including instructions that when executed on a processor, searches the term/phrase replacement map to match the user terms in the user expression for an expression in the term/phrase replacement map and replaces the user questions in accordance with the sequence of search terms.

19. The computer-implemented system of claim 18, wherein the question conversion engine including further instructions that when executed on a processor, uses the sequence of parts of speech words to search the term/phrase replacement map.

20. The computer-implemented system of claim 18, further comprising a phrase replacement procedure including instructions that when executed on a processor generates the expressions based on a plurality of question and answer pairs that are analyzed for terms frequently found in the answers of the question and answer pairs that are not found in the questions of the question and answer pairs.
